(19) United States
(12) Patent Application Publication
(10) Pub. No.: US 2003/0105632 A1
(43) Pub. Date: Jun. 5, 2003

(54) Syntactic and semantic analysis of voice commands

(76) Inventors: Serge Le Huitouze, Corps (FR); Frederic Soufflet, Chateaugiron (FR)

Correspondence Address: Joseph S Tripoli, Patent Operation, Thomson Multimedia Licensing Inc, CN 5312, Priceton, NJ, 08543-0028, US

(21) Appl. No.: 10/276,192

(22) PCT Filed: May 15, 2001
(86) PCT No.: PCT/FR01/01470

(30) Foreign Application Priority Data
May 23, 2000 (FR) 00/06576

(51) Int. Cl. G10L 17/00

(52) U.S. Cl. 704/246

(57) ABSTRACT

The invention relates to a voice recognition process comprising a step (601) of acoustic processing of voice samples (201) and a step (602) of determination of a command intended to be applied to at least one device, and in that said steps of acoustic processing and of determination of a command use a single representation (309) in memory (305) of a language model.

The invention also relates to corresponding devices (102) and computer program products.

The present invention pertains to the field of voice recognition.

More precisely, the invention relates to large vocabulary voice interfaces. It applies in particular to command and control systems, for example in the field of television and multimedia.

Information or control systems are making ever increasing use of a voice interface to make interaction with the user fast and intuitive. Since these systems are becoming more complex, the dialogue styles supported must be ever more rich, and one is entering the field of large vocabulary continuous voice recognition.

It is known that the design of a large vocabulary continuous voice recognition system requires the production of a language model which defines or approximates acceptable strings of words, these strings constituting sentences recognized by the language model.

In a large vocabulary system, the language model therefore enables a voice processing module to construct the sentence (that is to say the set of words) which is most probable, in relation to the acoustic signal which is presented to it. This sentence must then be analyzed by a comprehension module so as to transform it into a series of appropriate actions (commands) at the level of the voice controlled system.

At present, two approaches are commonly used by language models, namely models of N-gram type and grammars.

In the current state of the technology, language models of N-gram type are used in particular in voice dictation systems, since the aim of these applications is merely to transcribe the sound signal into a set of words, while systems based on stochastic grammars are present in voice command and control systems, since the sense of the sentence transcribed needs to be analyzed.

Within the framework of the present invention, stochastic grammars are therefore employed.

According to the state of the art, voice recognition systems using grammars are, for the most part, based on the standardized architecture of the SAPI model (standing for “Speech Application Programming Interface”) defined by the company Microsoft (registered trademark) and carry out two independent actions sequentially:

a recognition of sentence uttered with use of a language model; and

an analysis (“parsing”) of the sentence recognized.

The language model representation used at the level of the voice processing module makes it easy to ascertain the words which can follow a given work according to the assumption considered in the current step of the processing of the acoustic signal.

The grammar of the application is converted into a finite state automaton, since this representation facilitates the integration of the language model constituted by the grammar into the decoding schemes of N-best with pruning type commonly used in current engines. This technique is described in particular in the work “Statistical Methods for Speech Recognition”, written by Frederick Jelinek and published in 1998 by MIT Press.

The analysis module is generally a traditional syntactic analyzer (called a “parser”), which traverses the syntactic tree of the grammar and effects, at certain points, called “generating points”, semantic data determined a priori. Examples of analysis modules are described in the book “Compilateurs. Principes, techniques et outils” [Compilers. Principles, techniques and tools], written by Alfred Aho, Ravi Sethi and Jeffrey Ullman and published in 1989 by InterEditions.

The quality of a language model can be measured by the following indices:

Its perplexity, which is defined as the mean number of words which can follow an arbitrary word in the model in question. The lower the perplexity, the less the acoustic recognition algorithm is invoked, since it has to take a decision faced with a smaller number of possibilities.

Its memory room, that is to say the space it occupies in memory. This is especially important in respect of large-vocabulary embedded applications, in which the language model may be the part of the application consuming most memory.

A drawback of the prior art is in particular a relatively sizeable memory room for a language model having a given perplexity.

Furthermore, according to the state of the art, the sentence proposed by the recognition module is transmitted to the syntactic analysis module, which uses a “parser” to decode it.

Consequently, another drawback of this prior art technique is that there is a non-negligible waiting time for the user between the moment at which he speaks and the actual recognition of his speech.

The invention according to its various aspects has in particular the objective of alleviating these drawbacks of the prior art.

More precisely, an objective of the invention is to provide a voice recognition system and process making it possible to optimize the use of the memory for a given perplexity.

Another objective of the invention is to reduce the waiting time for the end of the voice recognition after a sentence is uttered.

With this aim, the invention proposes a voice recognition process noteworthy in that it comprises a step of acoustic processing of voice samples and a step of determination of a command intended to be applied to at least one device, and in that said steps of acoustic processing and of determination of a command use a single representation in memory of a language model.

It is noted that the language model comprises in particular:

elements allowing the step of acoustic processing, such as, for example, the elements present in a grammar customarily used by means of recognition of an uttered sentence; and

elements required for extracting a command such as for example, generating points described hereinbelow.

Here, command is understood to mean any action or collection of simultaneous and/or successive actions on a device in the form, in particular of dialogue, of control or of command in the strict sense.

It is noted, also, that the step of generation of a command makes it possible to generate a command which can under certain conditions be directly comprehensible by a device; in the case where the command is not directly comprehensible, its translation remains simple to perform.

According to a particular characteristic, the voice recognition process is noteworthy in that said step of acoustic processing of voice samples comprises the identification of at least one set of semantic data taking account of said voice samples and of said language model, said set directly feeding said command determination step.

It is noted that the expression “semantic data” signifies here “generating points”.

According to a particular characteristic, the voice recognition process is noteworthy in that said step of determination of a command comprises a substep of generation of a set of semantic data on the basis of said language model and of the result of said acoustic processing step, so as to allow the generation of said command.

According to a particular characteristic, the voice recognition process is noteworthy in that said substep of generation of a set of semantic data comprises the supplying of said semantic data in tandem with a trellis backtrack.

Thus, the invention allows, advantageously relatively simple and economical implementation, applicable in particular to large vocabulary language models.

Furthermore, the invention advantageously allows reliable recognition which, preferably, is based on the voice decoding of the elements necessary for the determination of a command.

The invention also relates to a voice recognition device, noteworthy in that it comprises means of acoustic processing of voice samples and means of determination of a command intended to be applied to at least one device, and in that said means of acoustic processing and of determination of a command use one and the same representation in memory of a language mode.

The invention relates, furthermore, to a computer program product comprising program elements, recorded on a medium readable by at least one microprocessor, noteworthy in that said program elements control said microprocessor or microprocessors so that they perform a step of acoustic processing of voice samples and a step of determination of a command intended to be applied to at least one device, said steps of acoustic processing and of determination of a command using one and the same representation in memory of a language model.

The invention relates, also, to a computer program product, noteworthy in that said program comprises sequences of instructions tailored to the implementation of the voice recognition process as described above when the program is executed on a computer.

The advantages of the voice recognition device, and of the computer program products are the same as those of the voice recognition process, they are not detailed more fully.

Other characteristics and advantageous of the invention will be more clearly apparent on reading the following description of a preferred embodiment, given by way of simple and nonlimiting illustrative example, and of the appended drawings, among which:

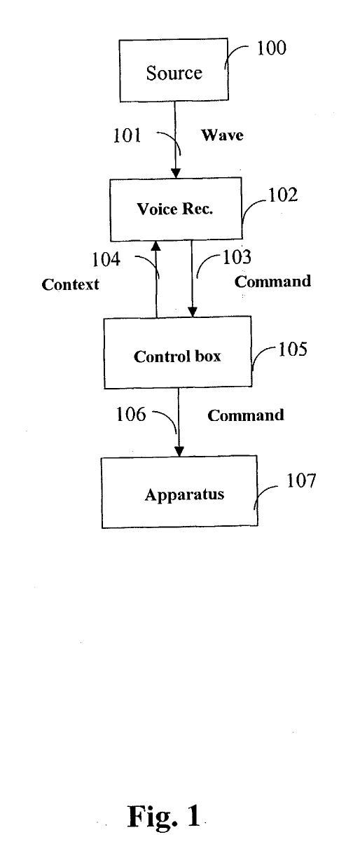

FIG. 1 depicts a general schematic of a system comprising a voice command box, in which the technique of the invention is implemented;

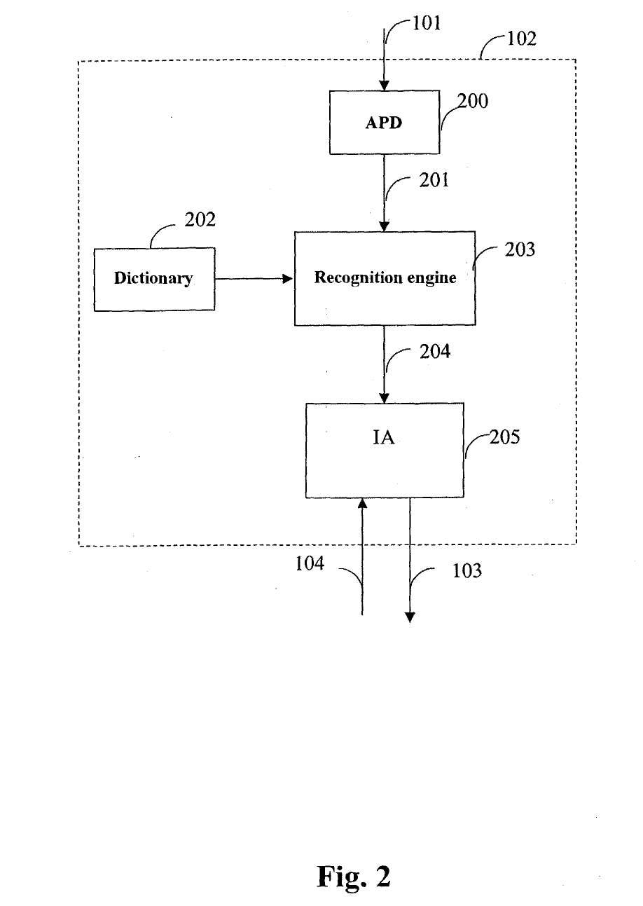

FIG. 2 depicts a schematic of the voice recognition box of the system of FIG. 1;

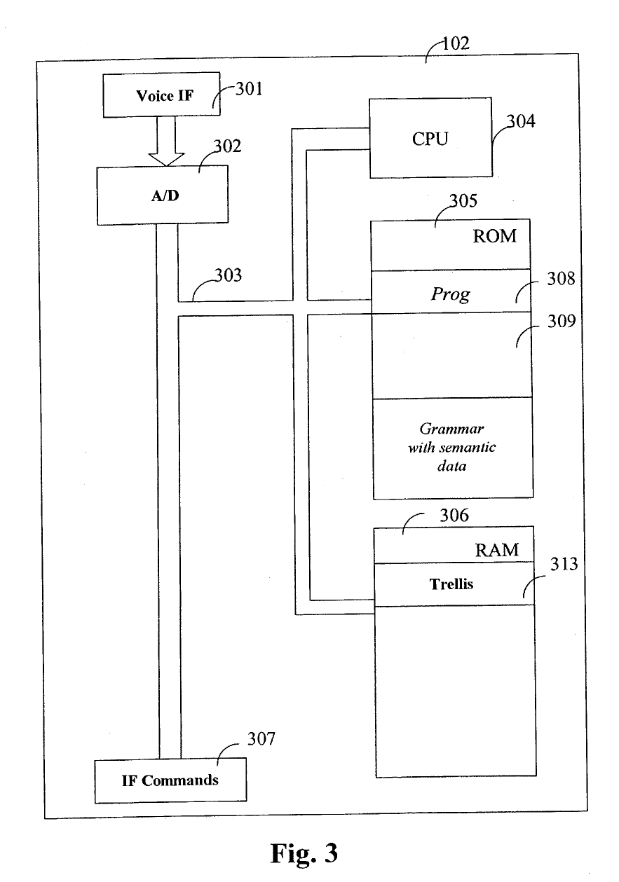

FIG. 3 describes an electronic layout of a voice recognition box implementing the schematic of FIG. 2;

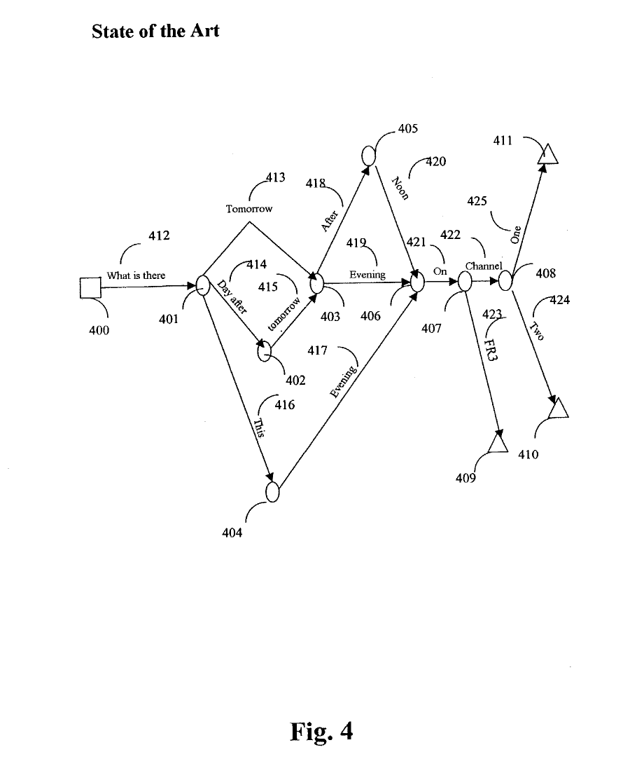

FIG. 4 describes a finite state automaton used according to a voice recognition process known per se;

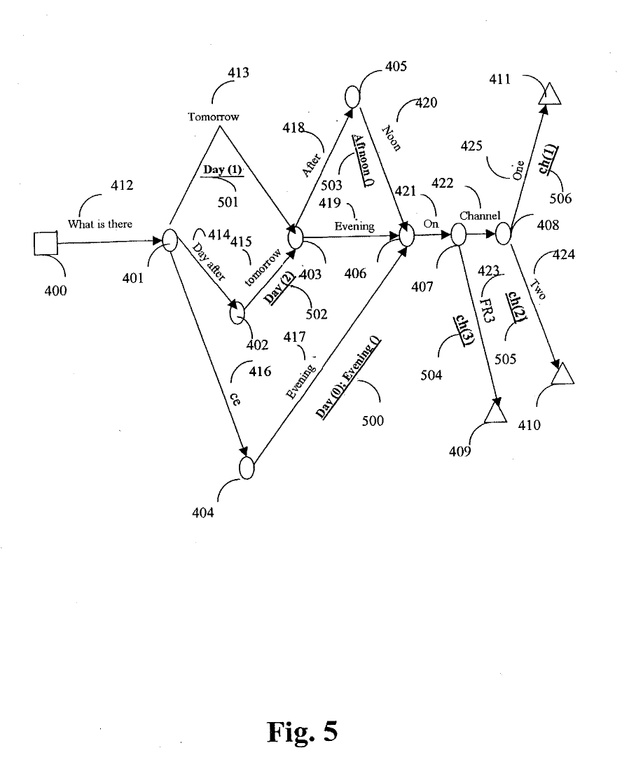

FIG. 5 describes a finite state automaton used by the box illustrated in conjunction with FIGS. 1 to 3; and

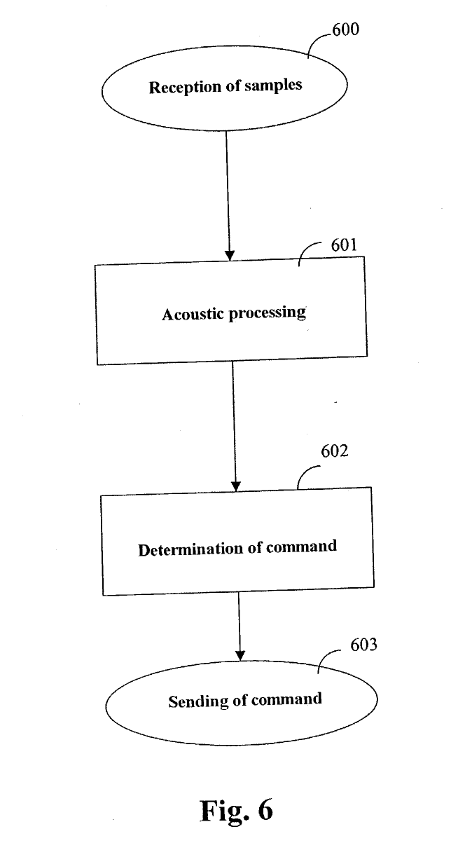

FIG. 6 describes a voice recognition algorithm implemented by the box illustrated in conjunction with FIGS. 1 to 3, based on the use of the automaton of FIG. 5.

The general principle of the invention therefore relies in particular, as compared with the known techniques, on a tighter collaboration between the voice processing module and the comprehension module, through the effective sharing of their common part, namely the language model.

The representation of this language model must be such that it allows its efficacious utilization according to both its schedules of use.

According to the invention, a single representation of the grammar is used. (Whereas according to the state of the prior art, the grammar is represented twice: a first time, for the language module, for example, typically in the form of a finite state automaton and a second time in the syntactic analyzer, for example in the form of a parser LL(k). Now, these two modules carry the same information duplicated in two different forms, namely the permitted syntactic strings.)

Furthermore, according to the invention, the phase of syntactic analysis (or of “parsing”) does not exist: no sentence is now exchanged between the two modules for analysis. The “backtracking” (or more explicitly “backtracking of the trellis”) conventionally used in voice recognition (as described in the work by Jelinek cited previously), is sufficient for the comprehension phase allowing the determination of a command.

The invention makes it possible to ensure the functionality required, namely the recognition of commands on the basis of voice samples. This functionality is ensured by a representation shared by the voice processing module and the comprehension module.

The two customary uses of grammar are firstly recalled:

to indicate the words which can follow a given set of words, so as to compare them with the acoustic signal entering the system;

starting from the set of words which is declared to be the most probable, to analyze it so as to ascertain its structure, and thus to determine the actions to be performed on the voice controlled system.

According to the invention, the shared structure comprises the information relevant to both uses.

More precisely, it represents an assumption (in our context, a left commencement of sentence) such that it is easy to extract therefrom the words which can extend this commencement, and also to be able to repeat the process by adding an extra word to an existing assumption. This covers the requirements of the voice processing module.

Additionally, the shared structure contains, in the case of a “terminal” assumption (that is to say correspondent to a complete sentence), a representation of the associated syntactic tree. A refinement is integrated at this level: rather than truly representing the syntactic tree associated with a terminal assumption, the sub-collection which is relevant from the point of view of the comprehension of the sentence, that is to say of the actions to be performed on the voice controlled system, is represented. This corresponds to what is done, according to the prior art techniques in syntactic analyzers. According to the invention, only that sub-collection of the syntactic tree which conveys the sense is of interest, rather than the complete syntactic tree (corresponding to the exhaustive string of rules which made it possible to analyze the input text). The construction of the meaningful part is done by means of the “generating points” such as described in particular in the book by Alfred Aho, Ravi Sethi and Jeffrey Ullman cited previously.

The generating points make it possible to associate a meaning with a segment of sentence. They may for example be:

key words relating to this meaning; or

references to procedures acting directly on the system to be controlled.

A general schematic of a system comprising a voice command box 102 implementing the technique of the invention is depicted in conjunction with FIG. 1.

It is noted that this system comprises in particular:

a voice source 100 which can in particular consist of a microphone intended to pick up a voice signal produced by a speaker;

a voice recognition box 102;

a control box 105 intended to operate an apparatus 107;

a controlled apparatus 107, for example of television or video recorder type.

The source 100 is connected to the voice recognition box 102, via a link 101 which enables it to transmit an analogue source wave representative of a voice signal to the box 102.

The box 102 can retrieve context information 104 (such as for example, the type of apparatus 107 which can be driven by the control box 105 or the list of command codes) via a link 104 and sends commands to the control box 105 via a link 103.

The control box 105 sends commands via a link 106, for example, infrared, to the apparatus 107.

According to the embodiment considered the source 100, the voice recognition box 102 and the control box 105 form part of one and the same device and thus the links 101, 103 and 104 are internal links within the device. On the other hand, the link 106 is typically a wireless link.

According to a first variant embodiment of the invention described in FIG. 1, the elements 100, 102 and 105 are partly or completely separate and do not form part of one and the same device. In this case, the links 101, 103 and 104 are external wire links or otherwise.

According to the second variant, the source 100, the boxes 102 and 105 and the apparatus 107 form part of one and the same device and are connected together by internal busses (links 101, 103, 104 and 106). This variant is especially beneficial when the device is, for example, a telephone or a portable telecommunication terminal.

FIG. 2 depicts a schematic of a voice command box such as the box 102 illustrated in conjunction with FIG. 1.

It is noted that the box 102 receives from outside the analogue source wave 101 which is processed by an Acoustic-Phonetic Decoder 200 or APD (possibly referred to simply as a “front-end”). The APD 200 samples the source wave 101 at regular intervals (typically every 10 ms) so as to produce real vectors or vectors belonging to code books, typically representing oral resonances which are transmitted via a link 201 to a recognition engine 203.

It is recalled that an acoustic-phonetic decoder translates the digital samples into acoustic symbols chosen from a predetermined alphabet.

A linguistic decoder processes these symbols with the aim of determining, for a sequence A of symbols, the most probable sequence W of words, given the sequence A. The linguistic decoder comprises a recognition engine using an acoustic model and a language model. The acoustic model is for example a so-called (“Hidden Markov Model” or HMM). It calculates in a manner known per se the acoustic scores of the word sequences considered. The language model implemented in the present exemplary embodiment is based on a grammar described with the aid of syntax rules of Backus Naur form. The language model is used to determine a plurality of assumptions of sequences of words and to calculate linguistic scores.

The recognition engine is based on a Viterbi type algorithm referred to as “n-best”. The n-best type algorithm determines at each step of the analysis of a sentence the n sequences of words which are most probable. At the end of the sentence, the most probable solution is chosen from among the n candidates, on the basis of the scores supplied by the acoustic model and the language model.

The manner of operation of the recognition engine is now described more especially. As mentioned, the latter uses a Viterbi type algorithm (n-best algorithm) to analyze a sentence composed of a sequence of acoustic symbols (vectors). The algorithm determines the N sequences of words which are most probable, given the sequence A of acoustic symbols which is observed up to the current symbol. The most probable sequences of words are determined through the stochastic grammar type language model. In conjunction with the acoustic models of the terminal elements of the grammar, which are based on HMMs (“Hidden Markov Models”), a global hidden Markov model is then produced for the application, which therefore includes the language model and for example the phenomena of coarticulations between terminal elements. The Viterbi algorithm is implemented in parallel, but instead of retaining a single transition to each state during iteration i, the N most probable transitions are retained for each state.

Information relating in particular to the Viterbi algorithm, beam search algorithm and “n-best” algorithm are given in the work:

“Statistical methods for speech recognition” by Frederik Jelinek, MIT press 1999 ISBN 0-262-10066-5 chapters 2 and 5 in particular.

The recognition engine makes use of a trellis consisting of the states at each previous iteration of the algorithm and of the transitions between these states, up to the final states. Ultimately, the N most probable transitions are retained from among the final states and their N associated transitions. By retracing the transitions from the final states, the generating points allowing direct determination of the command corresponding to the applicable acoustic symbols are determined without having to determine precisely the N most probable sequences of words of a complete sentence. Thus, there is no need here to call upon a specific processing using a “parser” with the aim of selecting the single final sequence on grammatical criteria.

Thus, with the aid of a grammar 202 with semantic data, the recognition engine 203 analyses the real vectors which it receives, using in particular Hidden Markov Models or HMMs and language models (which represent the probability of one word following another) according to a Viterbi algorithm with trellis backtracking enabling it to directly determine the applicable command containing only the necessary key words.

The recognition engine 203 supplies the semantic data which it has identified on the basis of the vectors received to a means for translating these words into commands which can be understood by the apparatus 107. This means uses an artificial intelligence translation process which itself takes into account the context 104 supplied by the control box 105 before transmitting one or more commands 103 to the control box 105.

FIG. 3 diagrammatically illustrates a voice recognition module or device 102 such as illustrated in conjunction with FIG. 1, and implementing the schematic of FIG. 2.

The box 102 comprises connected together by an address and data bus:

a voice interface 301;

an analogue-digital converter 302

a processor 304;

a nonvolatile memory 305;

a random access memory 306; and

an apparatus control interface 307.

Each of the elements illustrated in FIG. 3 is well known to the person skilled in the art. These commonplace elements are not described here.

It is observed moreover that the word “register” used throughout the description designates in each of the memories mentioned, both a memory area of small capacity (a few data bits) and a memory area of large capacity (making it possible to store an entire program or the whole of a sequence of transaction data).

The nonvolatile memory 305 (or ROM) hold in registers which for convenience possess the same names as the data which they hold:

the program for operating the processor 304 in a “prog” register 308; and

a grammar with semantic data in a register 309.

The random access memory 306 holds data, variables and intermediate results of processing and comprises in particular a representation of a trellis 313.

The principle of the invention is now illustrated within the framework of large vocabulary voice recognition systems using grammars to describe the language model, recalling, firstly, the manner of operation of the recognition systems of the prior art all of which use grammars operating in the manner sketched below.

According to the prior art, the language model of the application is described in the form of a grammar of BNF type (Backus Naur form): the collection of sentences which can be generated by successively rewriting the rules of the grammar constitute precisely what the application will have to recognize.

This grammar serves to construct a finite state automaton which is equivalent to it. This automaton supplies precisely the information necessary to the voice processing module, as described previously:

the states correspond to assumptions (sentence beginnings), with an initial state corresponding to the very beginning of the sentence, and the final states corresponding to the terminal assumptions (that is to say to complete sentences of the grammar);

the transitions correspond to the words which can come immediately after the assumption defined by the starting state of the transition, and they lead to a new assumption defined by the finishing state of the transition.

This principle is illustrated on an exemplary grammar with the aid of FIG. 4 which describes a finite state automaton used according to a voice recognition process of the state of the art.

For the sake of clarity, a model of small size is considered, this corresponding to the recognition of a question related to the television channel programme. Thus, it is assumed that a voice control box has to recognize a sentence of the type “What is there on a certain date on a certain television channel? ”. The date considered may be: “this evening”, “tomorrow afternoon”, “tomorrow evening” or “the day after tomorrow evening”. The television channel may be “FR3 ”, “one” or “two”.

According to FIG. 4, the corresponding finite state automaton comprises nodes (represented by a square for the initial state, triangles for the final states and circles the intermediate states) and branches or transitions (represented by arrows) between nodes.

It is noted that the transitions correspond to possibilities of isolated words in a sentence (for example, the words “this” 416, “evening” 417 or tomorrow 413, 415, the intermediate nodes marking the separation between various words.

This automaton enables the acoustic processing module to determine the allowable strings of Markovian phonetic models, (or HMMs) associated with the words of the grammar. The comparison of these allowable strings with the acoustic signal makes it possible to consider just the most probable ones, so as finally to select the best string when the acoustic signal is fully processed.

Thus, the acoustic processing module forms a trellis corresponding to this automaton by calculating the various metrics on the basis of the voice samples received. Next, it then determines the most likely final node 409, 410 or 411 so as to reconstruct, by backtracking through the trellis the corresponding string of words, thereby enabling the recognized sentence to be constructed completely.

It is this complete sentence which constitutes the output of the voice processing module, and which is supplied as input to the comprehension module.

The analysis of the recognized sentence is performed conventionally by virtue of a “parser” which verifies that this sentence does indeed conform to the grammar and extracts the “meaning” thereof. To do this, the grammar is enhanced with semantic data (generating points) making it possible precisely to extract the desired information from the sentences.

By considering the above example, the grammar is enhanced in such a way that all the information necessary for the application is available after analysis. In this example, it is necessary to ascertain the date (today, tomorrow, or the day after tomorrow), the period during the day (the afternoon or the evening) and the channel (1, 2, or 3). Generating points are therefore available for apprising the applicative part as to the sense conveyed by the sentence. A possible grammar for this application is presented below:

<G> = what is there <Date> on <Channel>
<Date> = this evening {day(0);evening();} |

<Date1><Complement>

<Date1> = tomorrow {day(1);} |

day after tomorrow {day(2);}

<Complement> = evening {evening();} |

afternoon {aftnoon();}

<Channel> = one {ch(1);} | two {ch(2);} |

FR3 {ch(3);}

where

the sign “|” represents an alternative (“A|B” therefore signifying “A or B”)

the terms between angle brackets indicate an expression or sentence which can be decomposed into words;

the isolated terms represent words; and

the terms in bold between curly brackets represent generating points.

For example, the terms {day(0)}, {day(1)} and {day(2)} respectively represent the current day, the day after and two days after.

An extended automaton can then be constructed which does not merely describe the strings of words which are possible, but which also advises of the “meaning” of these words. It is sufficient to enhance the formalism used to represent the automaton by adding generating points to it at the level of certain arcs which so require.

With such a representation, the customary phase of backtracking through the trellis, making it possible to rebuild the sentence recognized at the end of the Viterbi algorithm, can be slightly modified so as to rebuild the set of generating points rather than the set of words. This is a very tiny modification, since it simply involves collecting one item of information (represented in bold in the grammar above) rather than another (represented in normal characters in the grammar above).

According to the invention, FIG. 6 depicts a process of voice recognition based on the use of the automaton illustrated in FIG. 5 and used in the voice recognition box 102 as represented in conjunction with FIGS. 1 to 3.

In the course of a first step 600, the box 102 begins receiving voice samples which it has to process.

Next, in the course of a step 601 of acoustic processing of voice samples, the box 102 constructs a trellis based on the automaton of FIG. 5 as a function of the samples received.

By considering an example similar to that described previously, the automaton of FIG. 5 comprises in particular the elements of an automaton (with the words appearing above the transition arcs and in normal characters) such as illustrated in conjunction with FIG. 4 enhanced with possible generating points (below the transition arcs and in bold characters).

Thereafter, in the course of a step 602 of determination of a command, the box 102 backtracks through the trellis constructed during the previous step so as to directly estimate a set of generating points corresponding to a command.

This command is interpreted directly in the course of a step 603 in order to be transmitted to one or more devices for which it is intended, in a language comprehensible to this or these devices.

Thus, one constructs initially the trellis (step 601) then backtracks through the trellis without constructing a complete sentence but simply generating the sequence of generating points necessary for the determination of a command. In this way the same voice model representation in the form of an automaton is shared by an acoustic step and a command estimation step.

More precisely, the automaton comprises the relevant sub-collection of semantic information (comprising in particular the generating points) so as to allow fast access thereto without needing to reconstruct the recognized sentence.

Thus, according to the invention, it is no longer necessary to reconstruct the sentence recognized as such.

Furthermore, it is therefore no longer necessary to have a syntactic analyzer (this allowing a saving of space in terms of size of the application code), nor obviously to carry out the syntactic analysis (this affording a saving of execution time, all the more so since this time cannot be masked by the user's speaking), since an efficacious representation is directly available for performing the actions at the controlled system level.

Of course, the invention is not limited to the exemplary embodiments mentioned above.

Likewise, the voice recognition process is not limited to the case where a Viterbi algorithm is implemented but to all the algorithms using a Markov model, in particular in the case of algorithms based on trellises.

In a general manner, the invention applies to any voice recognition based on the use of a grammar which does not necessitate the complete reconstruction of a sentence to generate an apparatus command on the basis of voice samples.

The invention is especially useful in the voice command of a television or of some other type of mass-market apparatus.

Additionally, the invention allows a saving of energy, in particular when the process is implemented in a device with a standalone energy source (for example an infrared remote control or a mobile telephone).

It is also noted that the invention is not limited to a purely hardware installation but that it can also be implemented in the form of a sequence of instructions of a computer program or any form which mixes a hardware part and a software part. In the case where the invention is installed partially or totally in software form, the corresponding sequence of instructions may be stored in a removable storage means (for example a diskette, a CD-ROM or a DVD-ROM) or otherwise, this storage means being partially or totally readable by a computer or a microprocessor.

1. A voice recognition process characterized in that it comprises a step (601) of acoustic processing of voice samples (201) and a step (602) of determination of a command intended to be applied to at least one device, and in that said steps of acoustic processing and of determination of a command use a single representation (309) in memory (305) of a language model.

2. The voice recognition process as claimed in claim 1, characterized in that said step of acoustic processing of voice samples comprises the identification of at least one set of semantic data (500 to 506) taking account of said voice samples and of said language model, said set directly feeding said command determination step.

3. The voice recognition process as claimed in any one of claims 1 and 2, characterized in that said step of determination of a command comprises a substep of generation of a set of semantic data on the basis of said language model and of the result of said acoustic processing step, so as to allow the generation of said command.

4. The voice recognition process as claimed in claim 3, characterized in that said substep of generation of a set of semantic data comprises the supplying of said semantic data in tandem with a trellis backtrack.

5. A voice recognition device, characterized in that it comprises means of acoustic processing of voice samples and means of determination of a command intended to be applied to at least one device, and in that said means of acoustic processing and of determination of a command use one and the same representation (309) in memory (305) of a language model.

6. A computer program product comprising program elements, recorded on a medium readable by at least one microprocessor, characterized in that said program elements control said microprocessor or microprocessors so that they perform a step of acoustic processing of voice samples and a step of determination of a command intended to be applied to at least one device, said steps of acoustic processing and of determination of a command using one and the same representation in memory of a language model.

7. A computer program product, characterized in that said program comprises sequences of instructions tailored to the implementation of a voice recognition process as claimed in any one of claims 1 to 4 when said program is executed on a computer.
